(19) United States
(12) Patent Application Publication
(10) Pub. No.: US 2021/0297497 A1
(43) Pub. Date: Sep. 23, 2021

(54) SYSTEM FOR CORRELATING SEPARATE EVENTS

(71) Applicant: Chartable Holding, Inc., New York, NY (US)

(72) Inventors: David ZOHROB, Irvington, NY (US); Harish AGARWAL, Brooklyn, NY (US)

(21) Appl. No.: 17/154,738

(22) Filed: Jan. 21, 2021

Related U.S. Application Data
(60) Provisional application No. 62/991,951, filed on Mar. 19, 2020.

(51) Int. Cl. H04L 29/08; H04L 29/12

(52) U.S. Cl. CPC H04L 67/26; H04L 61/2007; H04L 67/02

(57) ABSTRACT

Described are platforms, systems, and methods for correlating separate events involved in the download of an audio file. In one aspect, a method comprises receiving, from a user device, a first set of event data for a first event, the first event comprising a request for a web feed associated with an audio file, the first set of event data comprising an IP address; receiving, from the user device, a second set of event data for a second event, the second event comprising a request for the audio file, the second set of event data comprising the IP address; processing the first event data and the second event data to determine a correlation between the first event and the second event based on the IP address associated with the user device; and providing the correlation between the first event and the second event to a publisher of the audio file.

### CROSS-REFERENCE TO RELATED APPLICATIONS

This application claims the benefit of U.S. Provisional Application No. 62/991,951, filed Mar. 19, 2020, which is incorporated herein by reference in its entirety.

### BACKGROUND

A web feed or syndication feed is a popular format for providing users with frequently updated data and content. Web feeds can be used across a network of websites for products, news, audio files, or blogs. Users can subscribe to content and receive updated notifications via web feeds. Common formats employed to deliver web feeds include are Really Simple Syndication (or Rich Site Summary) (RSS) and extensible markup language (XML). The aggregation of a web feed is the act of making a collection of web feeds available on a single page.

### SUMMARY

Embodiments of the present disclosure are generally directed to a system that receives and processes events to correlate or attribute a resulting event for a download of a content item to a proceeding event requesting a web feed comprising the content item.

Podcasts have been around since at least the year 2004 but have seen significant growth in the past few years. Recent data shows that a third of adults in the United States alone listen to podcasts on a monthly basis, which is up 23 percent in one year. Generally, technology serving publishers provide information for their respective podcasts to users via a web feed, such as an RSS feed. RSS feeds were widely employed during the advent of weblogs.

Because the podcast industry was very niche for many years, technology serving publishers lagged other ecosystems, such as digital display ads and mobile advertisements. However, as the industry has grown rapidly in recent years, the demand from publishers for more quantitative tools to grow and market their product has increased substantially. To address this demand, the system described herein provides tracking all the way to the download by collecting both clicks and downloads through shareable, trackable Uniform Resource Locators (URLs) that can be employed to automatically route listeners via, for example, their favorite applications. The described system.

Accordingly, in one aspect, described herein are computer-implemented methods for correlating separate events involved in a download of an audio file. The methods are executed by one or more processors. The methods comprise: receiving, from a user device, a first set of event data for a first event, the first event comprising a request for a web feed associated with an audio file, the first set of event data comprising an internet protocol (IP) address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file. In some embodiments, the first set of event data comprises a first identifier for a first application that initiated the first event on the user device, wherein the second set of event data comprises a second identifier for a second application that initiated the second event on the user device, and wherein the correlation between the first event and the second event is determined based on the first identifier and the second identifier. In some embodiments, the first application and the second application are the same application. In some embodiments, the correlation between the first event and the second event is determined based on a respective time that the first event and the second event were received or initialed on the user device. In some embodiments, the methods comprise: after receiving the first set of event data, redirecting the request for the web feed to the publisher. In some embodiments, the methods comprise: after receiving the first set of event data, providing a location of the web feed to the user device. In some embodiments, the location of the web feed is provided to a podcast application executed by the user device. In some embodiments, the methods comprise: after receiving the second set of event data, redirecting the request for the audio file to the publisher. In some embodiments, the methods comprise: after receiving the second set of event data, providing a location of the audio file to the user device. In some embodiments, the location of the audio file is provided to a podcast application executed by the user device. In some embodiments, the first event is initiated from the user device via a shared link provided by the publisher. In some embodiments, the correlation between the first event and the second event is provided to the publisher within a summary of events, for a given timeframe, initiated via the shared link correlated to events for downloads of the audio file or related audio files. In some embodiments, the summary of events is provided to the publisher via a user interface. In some embodiments, the summary of events comprises at least one million correlated events. In some embodiments, the second event is initiated from the user device via a prefix code embedded in the web feed. In some embodiments, the web feed comprises a location of the audio file. In some embodiments, the web feed comprises an RSS feed. In some embodiments, the RSS feed is maintained by the publisher. In some embodiments, the audio file comprises a Moving Picture Experts Group (MPEG) Audio Layer-3 (MP3) file. In some embodiments, the audio file comprises an episode of a podcast. In some embodiments, the second set of event data is instead received from a second user device associated with the IP address. In some embodiments, the methods comprise: receiving, from the user device, subsequent sets of event data for the second event, wherein the second event comprises a request for a portion of the audio file, and wherein the second set of event data and each of the subsequent sets of event data comprise the portion of the audio file requested; determining, as a download indicator, whether an entirety of the audio file has been downloaded by the user device based on the received second set of event data and the subsequent sets of event data; and providing the download indicator to the publisher of the audio file.

In another aspect, described herein are non-transitory computer-readable storage media coupled to one or more processors and having instructions stored thereon which, when executed by the one or more processors, cause the one or more processors to perform operations. These operations comprise: receiving, from a user device, a first set of event data for a first event, the first event comprising a request for a web feed associated with an audio file, the first set of event data comprising an IP address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file. In some embodiments, the first set of event data comprises a first identifier for a first application that initiated the first event on the user device, wherein the second set of event data comprises a second identifier for a second application that initiated the second event on the user device, and wherein the correlation between the first event and the second event is determined based on the first identifier and the second identifier. In some embodiments, the first application and the second application are the same application. In some embodiments, the correlation between the first event and the second event is determined based on a respective time that the first event and the second event were received or initialed on the user device. In some embodiments, the methods comprise: after receiving the first set of event data, redirecting the request for the web feed to the publisher. In some embodiments, the methods comprise: after receiving the first set of event data, providing a location of the web feed to the user device. In some embodiments, the location of the web feed is provided to a podcast application executed by the user device. In some embodiments, the methods comprise: after receiving the second set of event data, redirecting the request for the audio file to the publisher. In some embodiments, the methods comprise: after receiving the second set of event data, providing a location of the audio file to the user device. In some embodiments, the location of the audio file is provided to a podcast application executed by the user device. In some embodiments, the first event is initiated from the user device via a shared link provided by the publisher. In some embodiments, the correlation between the first event and the second event is provided to the publisher within a summary of events, for a given timeframe, initiated via the shared link correlated to events for downloads of the audio file or related audio files. In some embodiments, the summary of events is provided to the publisher via a user interface. In some embodiments, the summary of events comprises at least one million correlated events. In some embodiments, the second event is initiated from the user device via a prefix code embedded in the web feed. In some embodiments, the web feed comprises a location of the audio file. In some embodiments, the web feed comprises an RSS feed. In some embodiments, the RSS feed is maintained by the publisher. In some embodiments, the audio file comprises an MP3 file. In some embodiments, the audio file comprises an episode of a podcast. In some embodiments, the second set of event data is instead received from a second user device associated with the IP address. In some embodiments, the methods comprise: receiving, from the user device, subsequent sets of event data for the second event, wherein the second event comprises a request for a portion of the audio file, and wherein the second set of event data and each of the subsequent sets of event data comprise the portion of the audio file requested; determining, as a download indicator, whether an entirety of the audio file has been downloaded by the user device based on the received second set of event data and the subsequent sets of event data; and providing the download indicator to the publisher of the audio file.

In another aspect, described herein are event correlation systems for correlating separate events involved in a download of an audio file. These systems comprise: a user device; one or more processors; and a computer-readable storage device coupled to the one or more processors and having instructions stored thereon which, when executed by the one or more processors, cause the one or more processors to perform operations. These operations comprise: receiving, from a user device, a first set of event data for a first event, the first event comprising a request for a web feed associated with an audio file, the first set of event data comprising an IP address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file. In some embodiments, the first set of event data comprises a first identifier for a first application that initiated the first event on the user device, wherein the second set of event data comprises a second identifier for a second application that initiated the second event on the user device, and wherein the correlation between the first event and the second event is determined based on the first identifier and the second identifier. In some embodiments, the first application and the second application are the same application. In some embodiments, the correlation between the first event and the second event is determined based on a respective time that the first event and the second event were received or initialed on the user device. In some embodiments, the methods comprise: after receiving the first set of event data, redirecting the request for the web feed to the publisher. In some embodiments, the methods comprise: after receiving the first set of event data, providing a location of the web feed to the user device. In some embodiments, the location of the web feed is provided to a podcast application executed by the user device. In some embodiments, the methods comprise: after receiving the second set of event data, redirecting the request for the audio file to the publisher. In some embodiments, the methods comprise: after receiving the second set of event data, providing a location of the audio file to the user device. In some embodiments, the location of the audio file is provided to a podcast application executed by the user device. In some embodiments, the first event is initiated from the user device via a shared link provided by the publisher. In some embodiments, the correlation between the first event and the second event is provided to the publisher within a summary of events, for a given timeframe, initiated via the shared link correlated to events for downloads of the audio file or related audio files. In some embodiments, the summary of events is provided to the publisher via a user interface. In some embodiments, the summary of events comprises at least one million correlated events. In some embodiments, the second event is initiated from the user device via a prefix code embedded in the web feed. In some embodiments, the web feed comprises a location of the audio file. In some embodiments, the web feed comprises an RSS feed. In some embodiments, the RSS feed is maintained by the publisher. In some embodiments, the audio file comprises an MP3 file. In some embodiments, the audio file comprises an episode of a podcast. In some embodiments, the second set of event data is instead received from a second user device associated with the IP address. In some embodiments, the methods comprise: receiving, from the user device, subsequent sets of event data for the second event, wherein the second event comprises a request for a portion of the audio file, and wherein the second set of event data and each of the subsequent sets of event data comprise the portion of the audio file requested; determining, as a download indicator, whether an entirety of the audio file has been downloaded by the user device based on the received second set of event data and the subsequent sets of event data; and providing the download indicator to the publisher of the audio file.

Particular embodiments of the subject matter described in this disclosure can be implemented so as to realize one or more of the following advantages. The described event attribution system attributes an event (e.g., an audio file download) to a preceding event (e.g., following a link to a web feed the includes the location of the audio file) to allow content creators to properly assess the value of, for example, a campaign targeted at driving downloads.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more embodiments of the present disclosure are set forth in the accompanying drawings and the description below. Other features and advantages of the present disclosure will be apparent from the description and drawings, and from the claims.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 depicts a non-limiting example architecture of the described event attribution system;

FIGS. 2A and 2B depict flowcharts of a non-limiting examples processes that can be implemented by embodiments of the present disclosure;

FIGS. 3A-3D depict various non-limiting example pages of a user interface (UI) by the described event attribution system.

FIG. 4 depicts a non-limiting example a computer system that can be programmed or otherwise configured to implement methods or systems of the present disclosure;

FIG. 5A depicts a non-limiting example environment that can be employed to execute embodiments of the present disclosure;

FIG. 5B depicts a non-limiting example application provision system that can be provided through an environment and employed to execute embodiments of the present disclosure; and

FIG. 5C depicts a non-limiting example cloud-based architecture of an application provision system that can be provided through an environment and employed to execute embodiments of the present disclosure.

### DETAILED DESCRIPTION

Described herein, in certain embodiments, are computer-implemented methods for correlating separate events involved in a download of an audio file. The methods are executed by one or more processors. The methods comprise: receiving, from a user device, a first set of event data for a first event, the first event comprising a request for a web feed associated with an audio file, the first set of event data comprising an IP address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file.

Also described herein, in certain embodiments, are non-transitory computer-readable storage media coupled to one or more processors and having instructions stored thereon which, when executed by the one or more processors, cause the one or more processors to perform operations. These operations comprise: receiving, from a user device, a first set of event data for a first event, the first event comprising a request for a web feed associated with an audio file, the first set of event data comprising an IP address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file.

Also described herein, in certain embodiments, are event correlation systems for correlating separate events involved in a download of an audio file. These systems comprise: a user device; one or more processors; and a computer-readable storage device coupled to the one or more processors and having instructions stored thereon which, when executed by the one or more processors, cause the one or more processors to perform operations. These operations comprise: receiving, from a user device, a first set of event data for a first event, the first event comprising a request for a web feed associated with an audio file, the first set of event data comprising an IP address associated with the user device; receiving, from the user device, a second set of event data for a second event, the second event comprising a request for the audio file, the second set of event data comprising the IP address associated with the user device; processing the first set of event data and the second set of event data to determine a correlation between the first event and the second event based on the IP address associated with the user device; and providing the correlation between the first event and the second event to a publisher of the audio file.

### Certain Definitions

Unless otherwise defined, all technical terms used herein have the same meaning as commonly understood by one of ordinary skill in the art to which this disclosure belongs.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

As used herein, the term “real-time” refers to transmitting or processing data without intentional delay given the processing limitations of a system, the time required to accurately obtain data and images, and the rate of change of the data and images. In some examples, “real-time” is used to describe the presentation of information obtained from components of embodiments of the present disclosure.

### Event Attribution System

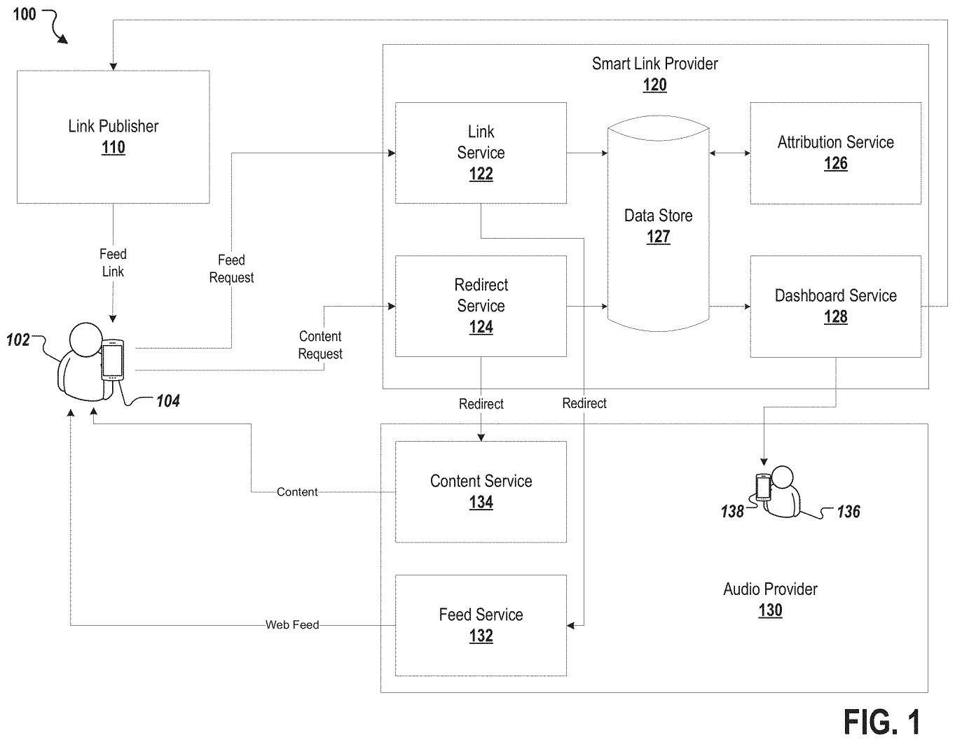

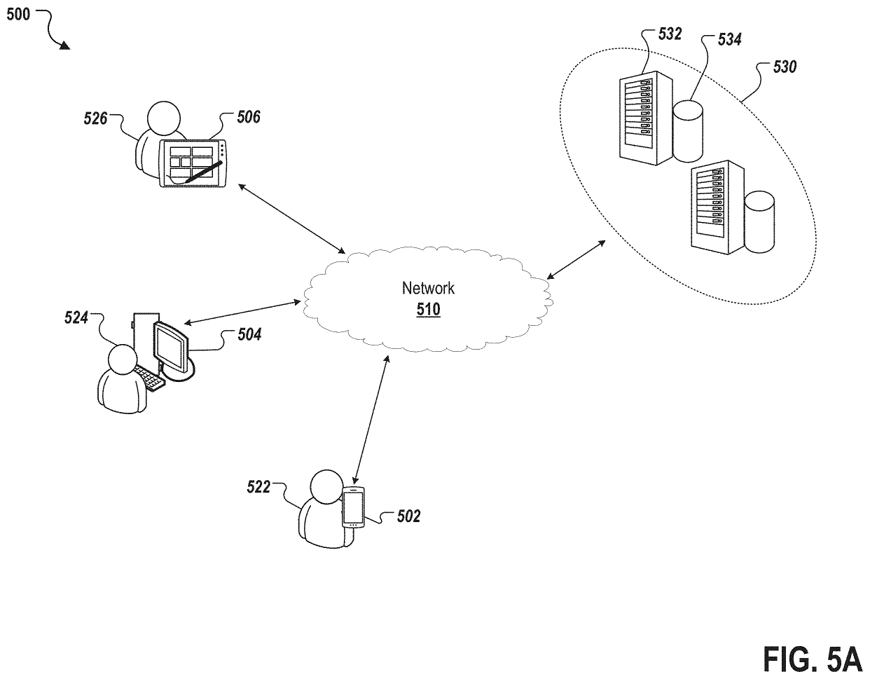

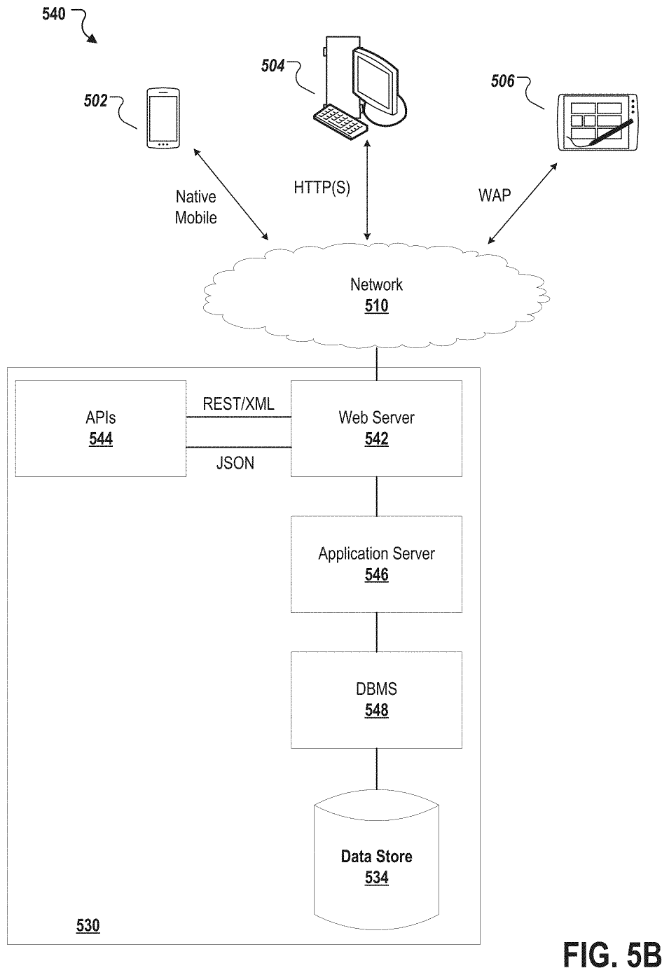

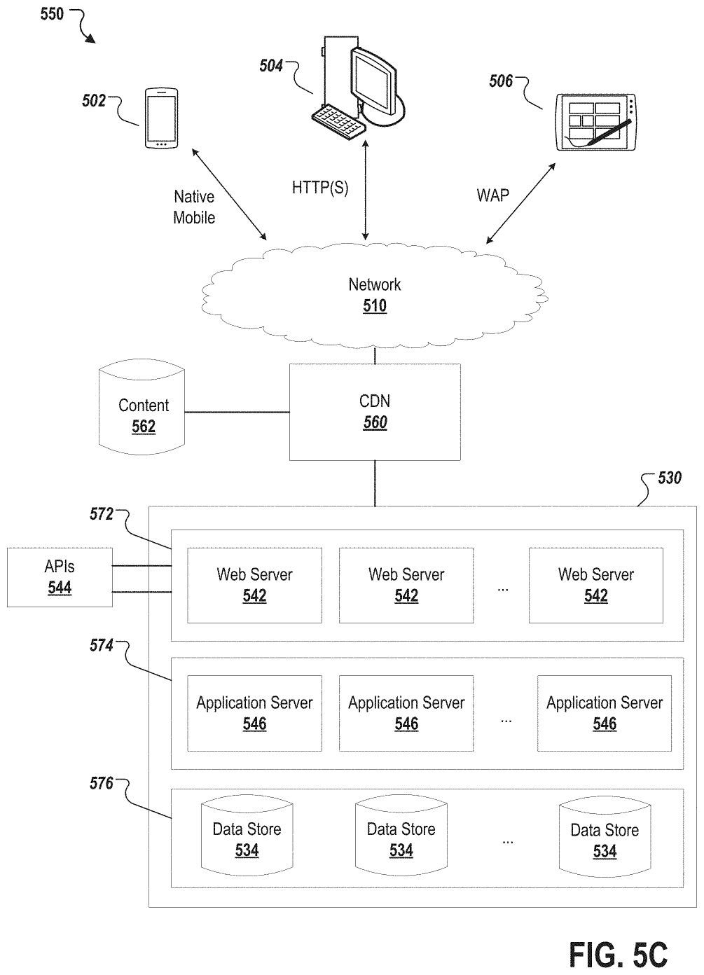

FIG. 1 depicts an example architecture 100 for the described smart links system. As depicted, the example architecture 200 includes a user 102, a user device 104, a link publisher 110, a smart link provider 120, and an audio provider 130. As depicted, the smart link provider 120 includes a link service 122, a redirect service 124, an attribution service 126, a dashboard service 128, and a data store 127. As depicted, the audio provider 130 includes a feed service 132 and a content service 134 as well as an administrator 136 that employs an administrator device 138 to view and configure information through the dashboard service 128. The user device 104 and the administrator device 138 can include any appropriate type of computing device. Such computing devices are described in greater detail below in the description of FIG. 5A. In some embodiments, the link published 110, the smart link provider 120, and the audio provider 130 are provided by separate enterprises. In some embodiments, two or more of the link publisher 110, the smart link provider 120, and the audio provider 130 are provider buy the same enterprise.

Generally, the audio provider 130 provides web feeds that include information regarding audio content, such as podcasts, which is also provided by the audio provider 130. The link publisher 110 provides content targeted to users. Such targeted content may include links to a web feed provided by the audio provider 130. For example, the link publisher 110 may provide target content to users for an online campaign for content provided by the audio provider 130. The smart link provider 120 facilitates the initial communication between the user device 104 and the audio provider 130 by, for example, receiving requests for content, such as a web feed or audio content; collecting and storing metric data regarding the user device 104; forwarding the requests to the audio provider 130; and providing attribution data to the audio provider 130. For example, the smart link provider 120 records the user 102 accessing, via target content provided by the link publisher 110, a web feed provided by the audio provider 130. The smart link provider also records the user 102 accessing/downloads audio content provided by the audio provider 130 that is included in the accessed web feed. The attribution service 126 attributes the recorded web feed access with the audio content download. The attributed data (and determined metric data) is provided to the administrator 136 via an application, such as a browser, executed on the administrator device 138 in communication with the dashboard service 128.

### Audio Provider

In some embodiments, the audio provider 130 provides audio content accessed via web feeds, such as an RSS feed. Such a web feed may include information regarding the location, content, format, and so forth of various audio files available from the audio provider 130. In some embodiments, the audio provider 130 embeds an analytics prefix in the provided web feeds for each of the embedded links to the audio content (e.g., links to each of the podcast episodes in the feed). In some embodiments, an analytics prefix may include parameters or a unique URL, for each link to audio content embedded in the web feed. For example, an analytics prefix for a content link of http://mypodcast.com/episode.mp3 may be embedded in a web feed as https://SLprovider.com/track/mypodcast.com/episode.mp3. In some embodiments, when the user 102 follows analytics prefix, the request is provided to the smart link provider 120 where the redirect service 124 logs the IP address and user agent data of the client on the user device 104 that is downloading the content before redirecting (e.g., via HTTP) to the content (e.g., the episode at mypodcast.com/episode.mp3).

In some embodiments, the user 102 employs the user device 104 to access audio content provided by the audio provider 130 via a web feed. The user 102 can employ an application, such as a pod cast application, on the user device 104 to access the web feed and download audio files. Example podcast application include: RadioPublic®, Pocket Casts®, Castbox®, Podbean®, Stitcher®, Laughable®, Spotify® and others.

### Link Publisher

In some embodiments, the link publisher 110 determines content to target to the user 102 regarding web feeds provided by the audio provider 130 that the user may have interest in viewing. As an example, as the user 102 views web content on the user device 104, the user 102 may be provided, from the link provider 110, a link for a specific type of audio content (e.g., through an advertisement). The type of audio content may be determined based on the user's 102 preference, browsing history, and so forth. When the user follows the provide link, the user obtains access to a web feed provided by the audio provider 130.

### Link Service

Generally, the link service 122 powers the links that publishers (e.g., the audio provider 130) share with their audiences via, for example an online campaign provided through the link publisher 110. In some embodiments, when the user 102 clicks or otherwise engages with a link provider by the link publisher 110, the user device 104 sends a request for a web feed to the link service 122. In some embodiments, the link service 122 records information regarding link clicks of target content provided to the user 102 and redirects the received request for a web feed provided by the audio provider 130. In some embodiments, the request includes parameters such as a redirect URL (e.g., to the feed service 132), the user device's 104 IP address, user-agent data, cookie data, unique identifiers assigned to the user device 104, unique identifiers regarding the link publisher 110, source identifiers, and so forth, which are recorded by the link service 122. Once the request data has been recorded, the link service 122 redirects the request to the feed service 132, which provides the requested web feed to the user device 104.

### Redirect Service

In some embodiments, when the user 102 engages with a particular content item included in the web feed (e.g., the user 102 presses play to listen to an episode on a podcast application), the application provides a request to the redirect service 124. In some embodiments, this provided request is based on the analytics prefix embedded in the web feed for the respective content item (e.g., an audio file). In some embodiments, the request includes (similar to the request received by the link service 122) parameters such as a redirect URL (e.g., to the content service 134), the user device's 104 IP address, user-agent data, cookie data, unique identifiers assigned to the user device 104, unique identifiers regarding the link publisher 110, source identifiers, and so forth, which are recorded by the link service 122.

In some embodiments, the audio provider 130 may specify “smart rules” for automatic redirection by the redirect service 124 to the content service 134. For example, when a smart rule matches to a particular application (e.g., a specific podcast application) or device (e.g., a particular phone model(s)), the request is redirected to the podcast for the specified podcast application. For example, the audio provider 130 can specify that all iPhone are automatically redirected shows in Apple® Podcasts.

In some embodiments, once the request data has been recorded, the redirect service 124 provides the user 102 a page that allows a user to select a player for the requested audio content. In some embodiments, the redirect service 124 checks for smart rules that match for the provided parameters, such as the IP address used by the user device 104. In some embodiments, when no smart rules are found to match the request, the redirect service 124 provides the player selection page to the user device 104. In some embodiments, the player selection page includes content allowing the user 102 to choose an application to listen to the content provided by the audio provider 130. In some embodiments, the list of players in the player selection page is filtered to match players compatible with the user device 104. For example, when the user device is an iPhone the list of players may include Apple Podcasts™, Spotify™, Stitcher™, Overcast™, and Pocket Casts™; when the user device 104 is an Android device, the list of player may include: Google Podcasts™ Spotify, Stitcher, Pocket Casts; and when the user device is a Mac the list of players may include Apple Podcasts, and Spotify. In some embodiments, the player selection page includes a direct link to the web feed. The user 102 may use such a direct link to the web feed, for example, when they are using a podcast application on the user device 104 for which the smart link provider 120 does not have direct links. In such example, the user can select the direct link to the web feed provided on the player selection to obtain the URL of the web feed and place it directly into the podcast application.

When a user selects a player, a redirect to the content service 132 is triggered. In some embodiments, redirection of the request provided to the redirect service 124 is manual (e.g., when the user selects a player from the player selection page). In some embodiments, redirection of the request provided to the redirect service 124 automatic (e.g., when the data provided in the request matched a smart rule).

In some embodiments, the link service 122 or the redirect service 124 are deployed as a web service (e.g., Sinatra®) to a platform as a service (PaaS), such as Heroku. In some embodiments, the link service 122 or the redirect service 124 performs a redirect (e.g., a 302 redirect) based on a request for content (e.g., a web feed or audio content) received from the user device 104. In some embodiments, the request includes a URL in the pattern ([URL]). In some embodiments, the received request includes parameters, such as TEAM_ID, which is an alphanumeric string that identifies a “team” that is able to see the statistics collected for the content (e.g., an MP3 file). In some embodiments, the redirect service 124 will perform the redirect to the content service 134 even when a team identifier does not correspond to a known team for the particular item of content.

In some embodiments, when the provided request to the redirect service 124 includes a Hypertext Transfer Protocol Secure (HTTPS) request, the redirect service 124 redirects the request to the audio provider 130 via HTTPS regardless of whether the final URL has an HTTP scheme attached. In some embodiments, when the provided request to the redirect service 124 includes a Hypertext Transfer Protocol (HTTP) request but the final URL has a scheme specified with HTTPS, the redirect service 124 redirects the request to the audio provider 130 via will redirect via HTTPS.

In some embodiments, once the link has been redirected, the redirect service 124 enqueues a message worker that writes to a centralized message queue. This architecture allows for very low latency for the user requests. In some embodiments, the message worker persist (e.g., to the message queue) for each received request a globally unique identifier, a timestamp of the request, the full URL received by the redirect service 124, the URL to which the request was redirected, and various parameters and headers includes in the received request such as TEAM_ID, User-Agent, and IP address.

In some embodiments, the message queue is periodically piped as raw logs to an object storage service object (e.g., an S3 bucket). In some embodiments, a download-counting service (not shown) processes the raw logs (e.g., according to the Interactive Advertising Bureau (IAB) Podcast Measurement Guidelines 2.0). In some embodiments, for every unique request that counts as a download (e.g., according to the IAB) Podcast Measurement Guidelines 2.0), the download-counting service persists information such as a unique ID, the IP address of the request; a timestamp; the user-agent data; a team ID, a content ID (e.g., a podcast ID); an episode I; a device ID; and other metrics such as whether the user downloaded the full file. In some embodiments, the client running on the user device 104 that is requesting content via the redirect service 124 makes multiple requests to download the content as these files can run to hundreds of megabytes (mb). As such, the client running on the user device 104 may send subsequent requests to the redirect service 124 through the analytic prefix. For example, the client may download the first one mb, then another mb, then ten mb, then twenty mb, and so forth. In such examples, the redirect service 124 may receive requests for HTTP “Byte Ranges” that specify which bytes of the file the client wants to receive. In some embodiments, the redirect service 124 employs this received request data to determine whether the user has downloaded the full file.

As described above, the link service 122 and the redirect service 124 record data provided by the user device and/or the application, such as the user device's IP address, user-agent data, and so forth. Such data may be embedded, for example, in headers or includes in packet data. In some embodiments, user-agent data includes a description/code for the application the user is using to engage with the content (e.g., the description of the podcast application the user is using to listen to the episode). The link service 122 and redirect service 124 may also record metric data for each received request such as the type of redirect (e.g., automatic or manual) and whether the request appears to be from a bot (e.g., a Googlebot) or from a datacenter IP range. In some embodiments, the data is recorded in the data store 127, which may be any suitable type of data store, such as a database. Data stores are described in greater detail below in the data store section. See FIGS. 5A-5C for various example architectures that may be employed to provide such services.

### Attribution Service

In some embodiments, the attribution service 126 synchronizes or links the data persisted by the link service 122 and the redirect service 124 to the data store 127. For example, the attribution service 126 links data received via the analytics prefixes (e.g., web feed content) and the link redirects (e.g., the links provided by the link publisher 110). In some embodiments, for every click on a link, the attribution service 126 searches for a corresponding download that matches data that identifies the user 102 or the user device 104 (e.g., the user device's IP address) within an attribution window. In some embodiments, when a download of an audio file is matched by the attribution service 126 to, for example, a link click from received targeted content, the download is attributed to the link click. In some embodiments, a default value is set for the attribution window. For example, the default value for the attribution window may be set to a value between five minutes up to seven days based on the audio provider's 130 requirements (shorter or longer periods are possible depending on the providers requirements). In some embodiments, the attribution service 126 is executed periodically (e.g., every few minutes, hourly, nightly, and so forth). In some embodiments, the attribution service 126 is executed continually as, for example, a background service. In some embodiments, the attribution service 126 filters out data received from bots (e.g. Googlebot) or known datacenter IP ranges. In some embodiments, the attribution service 126 attributes data from a download and attributed link click. Such data may include, for example, the timestamp of download, a source identifier specified on the click, the player/user-agent used to download the content, episode information, and so forth.

In some embodiments, the attribution service 126 updates statistics for each link on a periodic basis (e.g., every few minutes, every hour, every few hours, and so forth). These updated statistics include, for example, a total number of clicks; unique clicks, which are deduplicated by, for example, a cookie set in the link service 122; unique downloads, which are denoted by, for example, a unique IP address and the user-agent; new downloads, which are denoted by, for example, unique IP address and user-agent combinations that not downloaded content or a grouping of content (e.g., a particular podcast) before. In some embodiments, the attributed data is includes breaking out each statistic by, for example, episode downloaded; player used to download; source identifier, and so forth, which is viable via the dashboard service 128.

### Dashboard

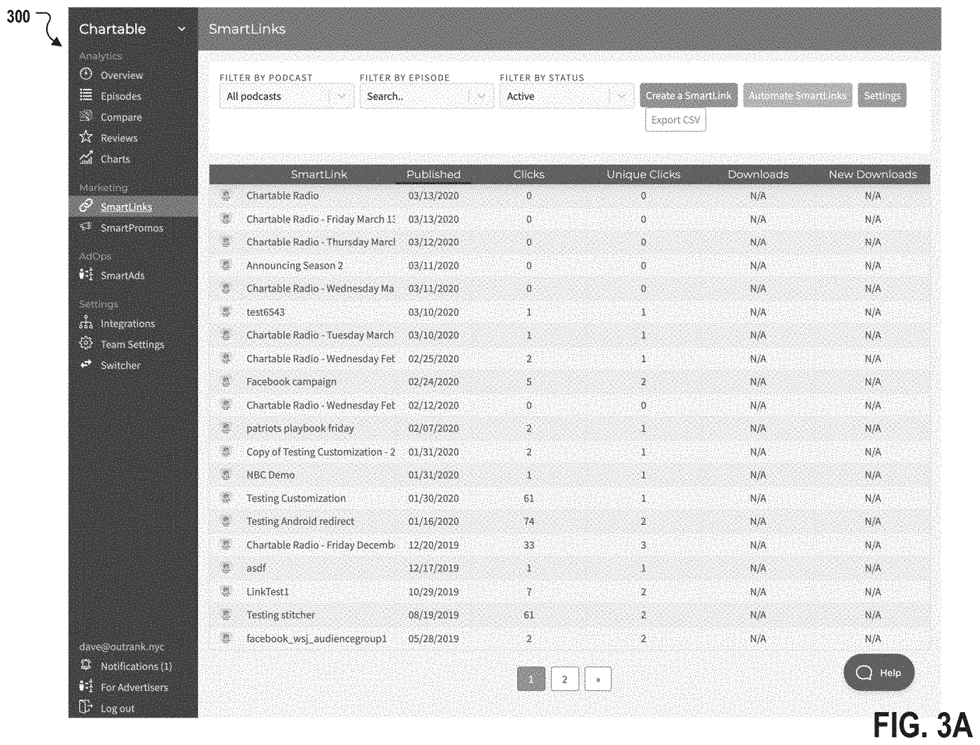

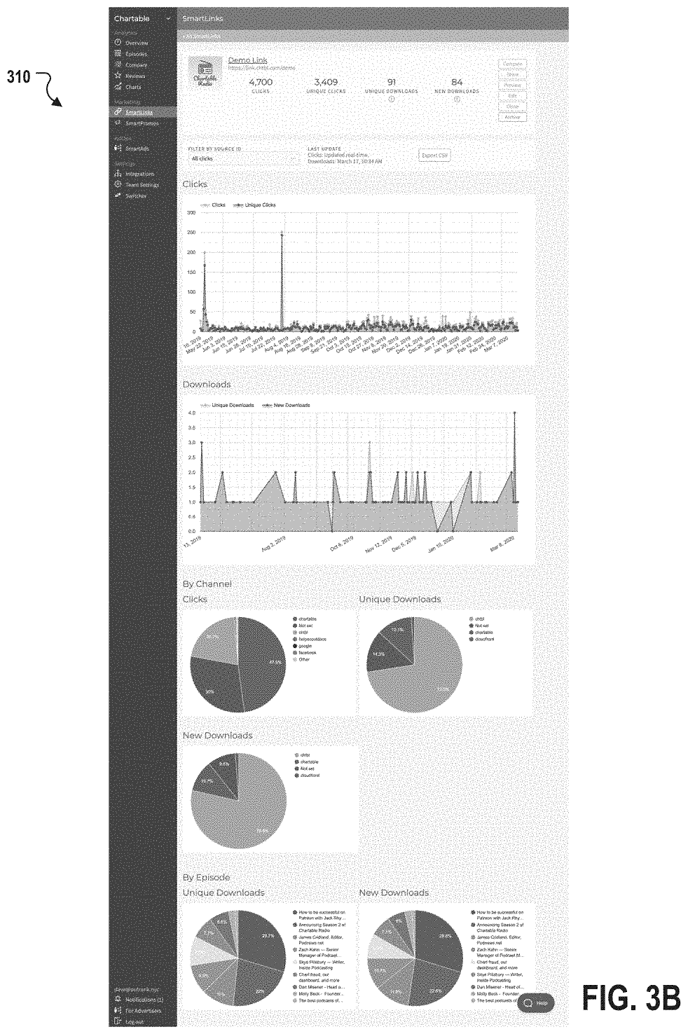

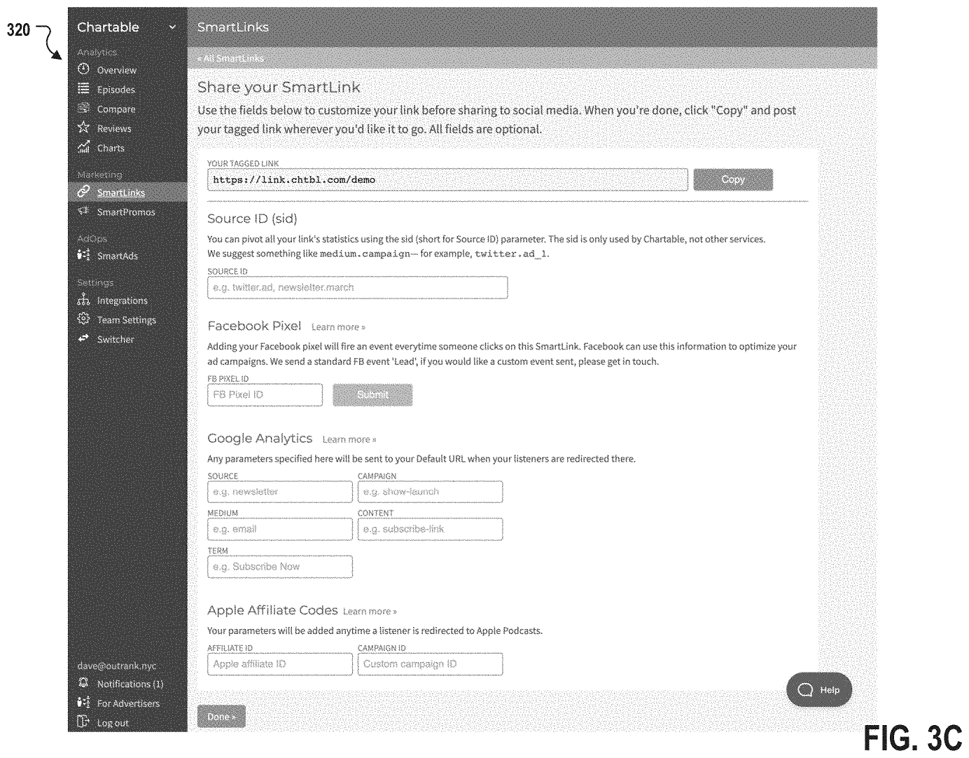

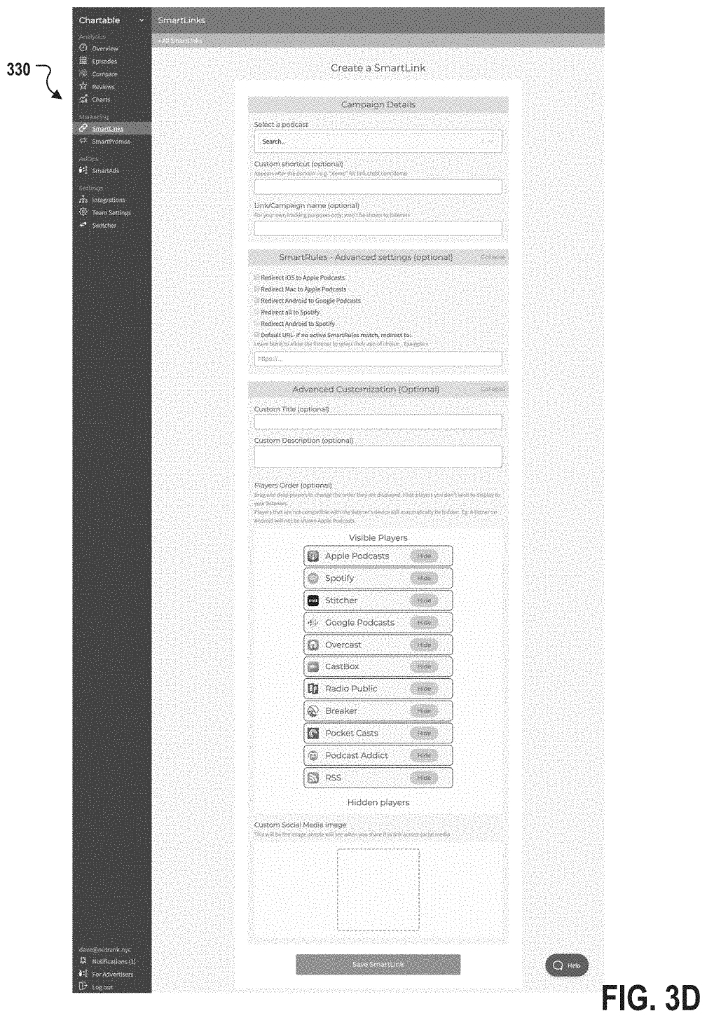

Generally, the dashboard service 128 allows the administrator 136, via the administrator device 138, to access attributed statistics and configure the instances of the link service 122 and redirect service 124 associated with the audio provider 130. In some embodiments, the dashboard service 128 provides functionality to create links (e.g., to provide to the link publisher 110) and view statistics regarding attributed downloads and link clicks. In some embodiments, the dashboard service 128 provides data for clicks, unique clicks, downloads, and new downloads (e.g., downloads from a user who has never downloaded a podcast before via the described system). In some embodiments, the administrator 136 may configure smart rules, such as described above, for particular content and web feeds via the dashboard service 128. In some embodiments, the dashboard service 128 provides reporting to the administrator 136 in real-time. For example, the reporting data may include an overview of all links compared to each other, a total count of attributed download as a timeseries, breakouts by episode, player and source identifiers. Examples pages for a UI presented via the dashboard service 128 are depicted in FIGS. 3A-3D.

### Example Processes

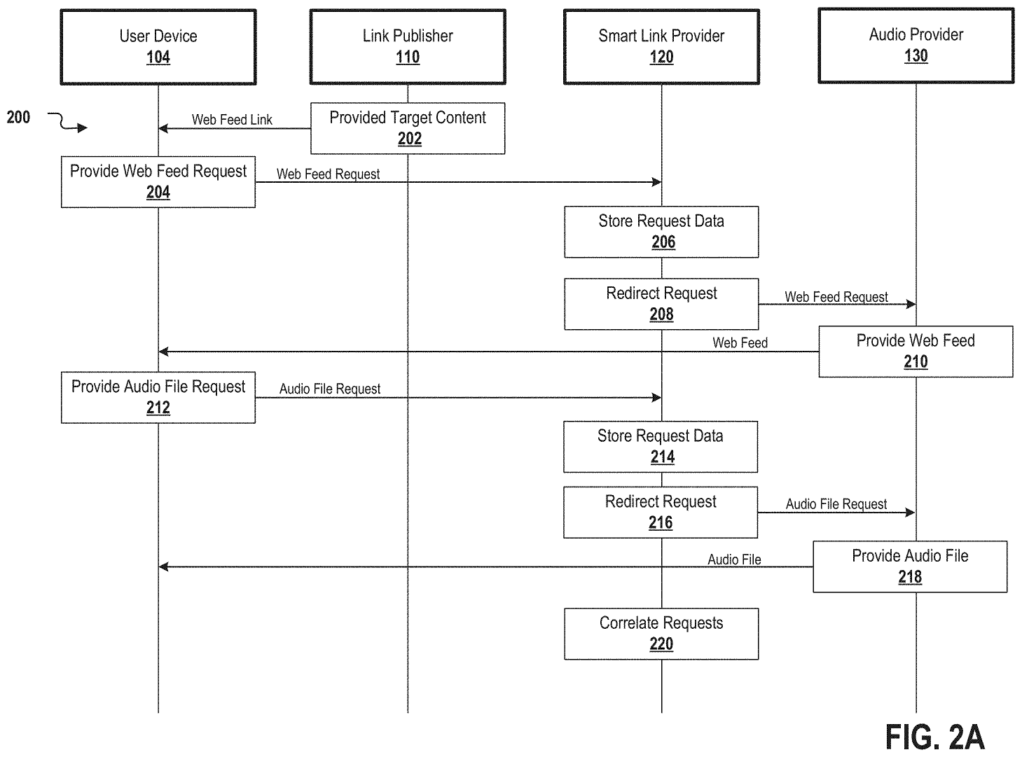

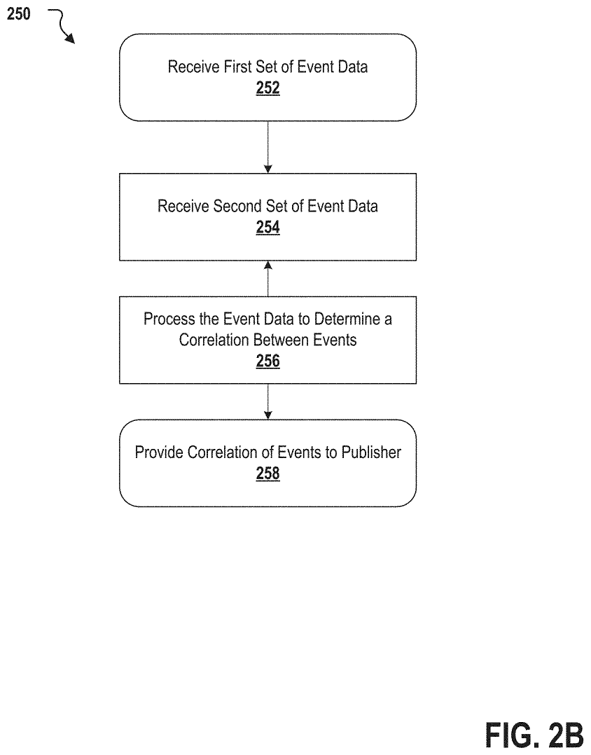

FIGS. 2A and 2B depicts flowchart of example processes 200 and 250 respectively that can be implemented by embodiments of the present disclosure. The example processes 200 and 250 can be implemented by the components of the described event attribution system, such as described above in FIG. 1. The example processes 200 and 250 generally shows in more detail how the describe system attributes a second event that includes a request for content, such as an audio file, with a first event that includes a request for a web feed.

For clarity of presentation, the description that follows generally describes the example processes 200 and 250 in the context of FIGS. 1, and 3A-6C. However, it will be understood that the processes 200 and 250 may be performed, for example, by any other suitable system, environment, software, and hardware, or a combination of systems, environments, software, and hardware as appropriate. In some embodiments, various operations of the processes 200 and 250 can be run in parallel, in combination, in loops, or in any order.

For FIG. 2A, process 200 shows an example distribution of work among components of the described event attribution system: the user device 104, the link publisher 110, the smart link provider 120, and the audio provider 130, which are described above and depicted in FIG. 1.

At 202, the link publisher 110 provides a link for a web feed as content targeted to the user of the user device 104. At 204, the user device provides a request for the web feed to the smart link provider 120. The request includes parameters that may include a redirect URL, an IP address, and user-agent data. At 206, the smart link provider 120 receives the request via, for example, the link service 122, and stores the request parameters in, for example, the data store 127. At 208, the smart link provider 120 forwards or redirects the request to the audio provider 130. At 210, the audio provider 130 provided the requested web feed to the user device 104 via, for example, the feed service 132. At 212, the user device, user the analytics prefix embedded in the web feed and associated with an audio file, provides a request for a with the audio file to the smart link provider 120. At 214, the smart link provider 120 receives the request via, for example, the redirect service 124, and stores the request parameters in, for example, the data store 127. At 216, the smart link provider 120 forwards or redirects the request to the audio provider 130. At 218, the audio provider 130 provided the requested audio file to the user device 104 via, for example, the content service 134. At 220, the smart link provider 120 attributes or correlates the request for the audio file with the request for the web feed via, for example, the attribution service 126. As described above, the attributed data (and determined metric data) can be provided to an administrator for the audio provider 130 via the dashboard service 128.

For process 250 depicted in FIG. 2B, at 252 a first set of event data for a first event is received from a user device, such as the user device 104 depicted in FIG. 1. In some embodiments, the first event comprises a request for a web feed associated with an audio file. In some embodiments, the first set of event data comprises an IP address associated with the user device. In some embodiments, after receiving the first set of event data, the request for the web feed is redirected to the publisher. In some embodiments, after receiving the first set of event data, a location of the web feed is provided to the user device. In some embodiments, the location of the web feed is provided to a podcast application executed by the user device. From 252, the process 250 proceeds to 254.

At 254, a second set of event data for a second event is received from the user device. In some embodiments, the second event comprises a request for the audio file. In some embodiments, the second set of event data comprises the IP address associated with the user device. In some embodiments, after receiving the second set of event data, the request for the audio file is redirected to the publisher. In some embodiments, after receiving the second set of event data, a location of the audio file is provided to the user device. In some embodiments, the location of the audio file is provided to a podcast application executed by the user device. In some embodiments, the second event is initiated from the user device via a prefix code embedded in the web feed. In some embodiments, the audio file comprises an MP3 file. In some embodiments, the audio file comprises an episode of a podcast. In some embodiments, the second set of event data is instead received from a second user device associated with the IP address. From 254, the process 250 proceeds to 256.

At 256, the first set of event data and the second set of event data to are processed to determine a correlation between the first event and the second event based on the IP address associated with the user device. In some embodiments, the first set of event data comprises a first identifier for a first application that initiated the first event on the user device. In some embodiments, the second set of event data comprises a second identifier for a second application that initiated the second event on the user device. In some embodiments, the correlation between the first event and the second event is determined based on the first identifier and the second identifier. In some embodiments, the first application and the second application are the same application. In some embodiments, the correlation between the first event and the second event is determined based on a respective time that the first event and the second event were received or initialed on the user device. In some embodiments, the web feed comprises a location of the audio file. From 256, the process 250 proceeds to 258.

At 258, the correlation between the first event and the second event is provided to a publisher of the audio file. In some embodiments, the first event is initiated from the user device via a shared link provided by the publisher. In some embodiments, the correlation between the first event and the second event is provided to the publisher within a summary of events, for a given timeframe, initiated via the shared link correlated to events for downloads of the audio file or related audio files. In some embodiments, the summary of events is provided to the publisher via a user interface. In some embodiments, the summary of events comprises at least one million correlated events. In some embodiments, the web feed comprises an RSS feed. In some embodiments, the RSS feed is maintained by the publisher. In some embodiments, subsequent sets of event data for the second event are received from the user device. In some embodiments, the second event comprises a request for a portion of the audio file. In some embodiments, the second set of event data and each of the subsequent sets of event data comprise the portion of the audio file requested. In some embodiments, whether an entirety of the audio file has been downloaded by the user device is determined as a download indicator based on the received second set of event data and the subsequent sets of event data. In some embodiments, the download indicator is provided to the publisher of the audio file. From 258, the process 250 ends.

### Example Pages

FIGS. 3A-3D depict various example pages provide by the described event attribution system via, for example, the dashboard service 128 as depicted in FIG. 1.

FIG. 3A depicts an example smart links dashboard page 300 for the described system. As depicted, the example page 300 provides content publishers, such as audio provider 130, an overview of their existing links. In some embodiments, the dashboard page 300 also provides sorting and filtering functionality. For example, publishers may sort/filter based on a particular podcast or episode or by the number of clicks or downloads. In some embodiments, the dashboard page 300 provides links to a detail view (depicted in FIG. 3B) for each listed item (e.g., podcast or episode)

FIG. 3B depicts an example link detail view page 310 for the described system. As depicted, the example page 310 provides summary statistics of clicks and downloads, along with a timeline of clicks and downloads. In some embodiments, link detail view page 310 also provides breakdowns of clicks and downloads by referrer or by parameters (e.g., source ID) received with the requests.

FIG. 3C depicts an example share page 320 for the described system. As depicted, the example share page 320 provides various tools to content publishers. Such tools may include functionality to, for example, annotate a link before sharing, pivoting stats (e.g., by Source ID), and integrating with other tools such as Facebook™, Google Analytics™ or Apple iTunes Affiliate Program™.

FIG. 3D depicts an example link creation page 330 for the described system. As depicted, the example link creation page 330 provides basic link creation. In some embodiments, link creation includes selecting a podcast and shortcut, naming a link, and providing redirection rules per-device. In some embodiments, the link creation page 330 provides advanced customization that allows, for example, reordering or hiding of specific players and specifying a custom title, description, or image for sharing on social media.

### Processing Devices and Processors

In some embodiments, the platforms, systems, media, and methods described herein include a computer, or use of the same. In further embodiments, the computer includes one or more hardware central processing units (CPUs) or general purpose graphics processing units (GPGPUs) that carry out the device's functions. In still further embodiments, the computer comprises an operating system configured to perform executable instructions. In some embodiments, the computer is optionally connected a computer network. In further embodiments, the computer is optionally connected to the Internet such that it accesses the World Wide Web. In still further embodiments, the computer is optionally connected to a cloud computing infrastructure. In other embodiments, the computer is optionally connected to an intranet. In other embodiments, the computer is optionally connected to a data storage device.

In accordance with the description herein, suitable computers include, by way of non-limiting examples, server computers, desktop computers, laptop computers, notebook computers, sub-notebook computers, netbook computers, netpad computers, handheld computers, Internet appliances, mobile smartphones, tablet computers, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the computer includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage or memory device. The storage or memory device is one or more physical apparatuses used to store data or programs on a temporary or permanent basis. In some embodiments, the device is volatile memory and requires power to maintain stored information. In some embodiments, the device is non-volatile memory and retains stored information when the computer is not powered. In further embodiments, the non-volatile memory comprises flash memory. In some embodiments, the volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, compact disc read-only memory (CD-ROM), digital versatile disc (DVD), flash memory devices, magnetic disk drives, magnetic tapes drives, optical disk drives, and cloud computing based storage. In further embodiments, the storage or memory device is a combination of devices such as those disclosed herein.

In some embodiments, the computer includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with a computer, such as a virtual reality (VR) headset. In further embodiments, suitable VR headsets include, by way of non-limiting examples, HTC Vive, Oculus Rift, Samsung Gear VR, Microsoft HoloLens, Razer Open-Source Virtual Reality (OSVR), FOVE VR, Zeiss VR One, Avegant Glyph, Freefly VR headset, and the like. In still further embodiments, the display is a combination of devices such as those disclosed herein.

In some embodiments, the computer includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

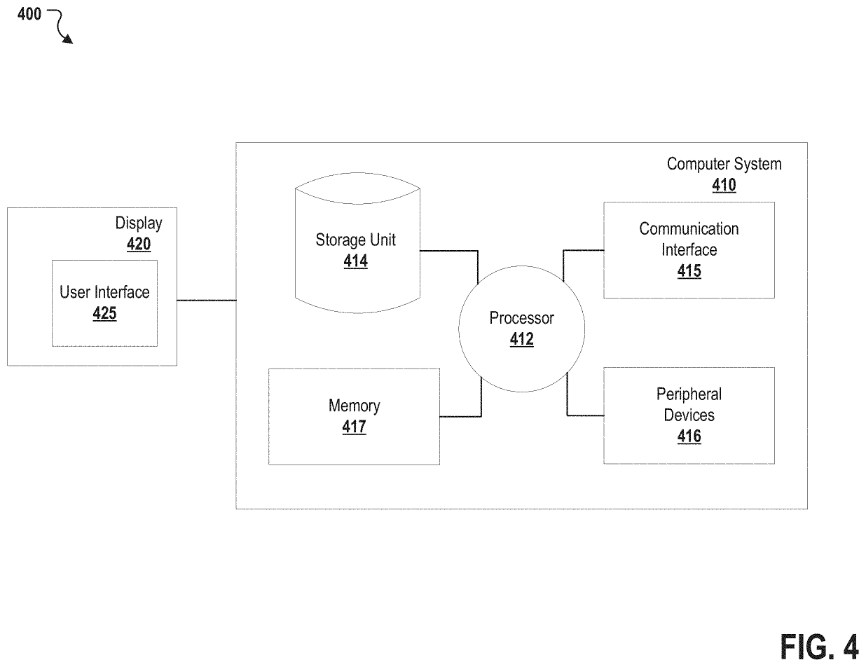

Computer control systems are provided herein that can be used to implement the platforms, systems, media, and methods of the disclosure. FIG. 4 depicts an example a computer system 410 that can be programmed or otherwise configured to implement platforms, systems, media, and methods of the present disclosure. For example, the computing device 410 can be programmed or otherwise configured to display a user-interface or application provided by the described system.

In the depicted embodiment, the computing device 410 includes a CPU (also “processor” and “computer processor” herein) 412, which is optionally a single core, a multi core processor, or a plurality of processors for parallel processing. The computing device 410 also includes memory or memory location 417 (e.g., random-access memory, read-only memory, flash memory), electronic storage unit 414 (e.g., hard disk), communication interface 415 (e.g., a network adapter) for communicating with one or more other systems, and peripheral devices 416, such as cache, other memory, data storage or electronic display adapters. In some embodiments, the memory 417, storage unit 414, interface 415 and peripheral devices 416 are in communication with the CPU 412 through a communication bus (solid lines), such as a motherboard. The storage unit 414 comprises a data storage unit (or data repository) for storing data. The computing device 410 is optionally operatively coupled to a computer network, such as the network 510 depicted and described in FIG. 5A, with the aid of the communication interface 415. In some embodiments, the computing device 410 is configured as a back-end server deployed within the described system.

In some embodiments, the CPU 412 can execute a sequence of machine-readable instructions, which can be embodied in a program or software. The instructions may be stored in a memory location, such as the memory 417. The instructions can be directed to the CPU 412, which can subsequently program or otherwise configure the CPU 412 to implement methods of the present disclosure. Examples of operations performed by the CPU 412 can include fetch, decode, execute, and write back. In some embodiments, the CPU 412 is part of a circuit, such as an integrated circuit. One or more other components of the computing device 410 can be optionally included in the circuit. In some embodiments, the circuit is an application specific integrated circuit (ASIC) or a FPGA.

In some embodiments, the storage unit 414 stores files, such as drivers, libraries and saved programs. In some embodiments, the storage unit 414 stores user data, e.g., user preferences and user programs. In some embodiments, the computing device 410 includes one or more additional data storage units that are external, such as located on a remote server that is in communication through an intranet or the internet.

In some embodiments, the computing device 410 communicates with one or more remote computer systems through a network. For instance, the computing device 410 can communicate with a remote computer system. Examples of remote computer systems include personal computers (e.g., portable PC), slate or tablet PCs (e.g., Apple® iPad, Samsung® Galaxy Tab, etc.), smartphones (e.g., Apple® iPhone, Android-enabled device, Blackberry®, etc.), or personal digital assistants. In some embodiments, a user can access the computing device 410 via a network.

In some embodiments, the platforms, systems, media, and methods as described herein are implemented by way of machine (e.g., computer processor) executable code stored on an electronic storage location of the computing device 410, such as, for example, on the memory 417 or the electronic storage unit 414. In some embodiments, the CPU 412 is adapted to execute the code. In some embodiments, the machine executable or machine readable code is provided in the form of software. In some embodiments, during use, the code is executed by the CPU 412. In some embodiments, the code is retrieved from the storage unit 414 and stored on the memory 417 for ready access by the CPU 412. In some situations, the electronic storage unit 414 is precluded, and machine-executable instructions are stored on the memory 417. In some embodiments, the code is pre-compiled. In some embodiments, the code is compiled during runtime. The code can be supplied in a programming language that can be selected to enable the code to execute in a pre-compiled or as-compiled fashion.

In some embodiments, the computing device 410 can include or be in communication with an electronic display 420. In some embodiments, the electronic display 420 provides a UI 425 that depicts various screen such as the examples depicted in FIGS. 3A-3D.

FIG. 5A depicts an example environment 500 that can be employed to execute embodiments of the present disclosure. The example system 500 includes computing devices 502, 504, 506, a back-end system 530, and a network 510. In some embodiments, the network 510 includes a local area network (LAN), wide area network (WAN), the Internet, or a combination thereof, and connects web sites, devices (e.g., the computing devices 502, 504, and 506) and back-end systems (e.g., the back-end system 530). In some embodiments, the network 510 includes the Internet, an intranet, an extranet, or an intranet or extranet that is in communication with the Internet. In some embodiments, the network 510 includes a telecommunication or a data network. In some embodiments, the network 510 can be accessed over a wired or a wireless communications link. For example, mobile computing devices (e.g., the smartphone device 502 and the tablet device 506), can use a cellular network to access the network 510.

In some examples, the users 522, 524, and 526 interact with the described system through a graphical user interface (GUI), such as depicted in FIGS. 3A-3D, or application that is installed and executing on their respective computing devices 502, 504, and 506. In some examples, the computing devices 502, 504, and 506 provide viewing data to screens with which the users 522, 524, and 526, can interact. In some embodiments, the computing devices 502, 504, 506 are sustainably similar to computing device 410 depicted in FIG. 4. The computing devices 502, 504, 506 may each include any appropriate type of computing device, such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. Three user computing devices 502, 504, and 506 are depicted in FIG. 5A for simplicity. In the depicted example environment 500, the computing device 502 is depicted as a smartphone, the computing device 504 is depicted as a tablet-computing device, and the computing device 506 is depicted a desktop computing device. It is contemplated, however, that embodiments of the present disclosure can be realized with any of the appropriate computing devices, such as those mentioned previously. Moreover, embodiments of the present disclosure can employ any number of devices as required.

In the depicted example environment 500, the back-end system 530 includes at least one server device 532 and at least one data store 534. In some embodiments, the device 532 is sustainably similar to computing device 410 depicted in FIG. 4. In some embodiments, the back-end system 530 may include server-class hardware type devices. In some embodiments, the server device 532 is a server-class hardware type device. In some embodiments, the back-end system 530 includes computer systems using clustered computers and components to act as a single pool of seamless resources when accessed through the network 510. For example, such embodiments may be used in data center, cloud computing, storage area network (SAN), and network attached storage (NAS) applications. In some embodiments, the back-end system 530 is deployed using a virtual machine(s). In some embodiments, the data store 534 is a repository for persistently storing and managing collections of data. Example data stores that may be employed within the described system include data repositories, such as a database as well as simpler store types, such as files, emails, and so forth. In some embodiments, the data store 534 includes a database. In some embodiments, a database is a series of bytes or an organized collection of data that is managed by a database management system (DBMS).

In some embodiments, the at least one server system 532 hosts one or more computer-implemented services, such as described above, provided by the described system that users 522, 524, and 526 can interact with using the respective computing devices 502, 504, and 506.

FIG. 5B depicts an example application provision system 540 that can be provided through an environment, such as the example environment 500 and employed to execute embodiments of the present disclosure. As depicted, the example application provision system 540 includes the back-end system 530 configured to include one or more data stores 534 accessed by a DBMS 548. Suitable DBMSs include Firebird, MySQL, PostgreSQL, SQLite, Oracle Database, Microsoft SQL Server, IBM DB2, IBM Informix, SAP Sybase, SAP Sybase, Teradata, and the like. As depicted, the example application provision system 540 includes the back-end system 530 configured to include one or more application severs 546 (such as Java servers, .NET servers, PHP servers, and the like) and one or more web servers 542 (such as Apache, IIS, GWS and the like). The web server(s) 542 optionally expose one or more web services via an API 544 via the network 510. In some embodiments, the example application provision system 540 provides browser-based or mobile native UIs to the computing devices 502, 504, 506. Optionally, as described above, webservices may be deployed to a PaaS, such as Heroku.

FIG. 5C depicts an example cloud-based architecture of an application provision system 550 that can be provided through an environment, such as the example environment 500, and employed to execute embodiments of the present disclosure. The application provision system 550 includes the back-end system 530 configured to include elastically load balanced, auto-scaling web server resources 572, application server resources 574, as well as synchronously replicated stores 576. In some embodiment, of the example cloud-based architecture of an application provision system 550, content 562 of services are provided through a content delivery network (CDN) 560 coupled with the back-end system 530. In some embodiments, a CDN is a geographically distributed network of proxy servers and respective data centers that provides high availability and high performance through distributing the service spatially relative to the receiving devices, such as commuting devices 502, 504, and 506.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the computer's CPU, written to perform a specified task. Computer readable instructions may be implemented as program modules, such as functions, objects, API, data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and eXtensible Markup Language (XML) database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or XML. In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile computer. In some embodiments, the mobile application is provided to a mobile computer at the time it is manufactured. In other embodiments, the mobile application is provided to a mobile computer via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Data Stores

In some embodiments, the platforms, systems, media, and methods disclosed herein include one or more data stores. In view of the disclosure provided herein, those of skill in the art will recognize that data stores are repositories for persistently storing and managing collections of data. Types of data stores repositories include, for example, databases and simpler store types, or use of the same. Simpler store types include files, emails, and so forth. In some embodiments, a database is a series of bytes that is managed by a DBMS. Many databases are suitable for receiving various types of data, such as weather, maritime, environmental, civil, governmental, or military data. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In some embodiments, a database is web-based. In some embodiments, a database is cloud computing-based. In some embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented method for correlating separate events involved in a download of an audio file, the method being executed by one or more processors and comprising:
receiving, from a user device, a first set of event data for a first event, the first event comprising a request for a web feed associated with the audio file, the first set of event data comprising an internet protocol (IP) address associated with the user device;
receiving, from the user device, a second set of event data for a second event, the second event comprising a request for the audio file, the second set of event data comprising the IP address associated with the user device;
processing the first set of event data and the second set of event data to determine a correlation between the first event and the second event based on the IP address associated with the user device; and
providing the correlation between the first event and the second event to a publisher of the audio file.

2. The method of claim 1, wherein the first set of event data comprises a first identifier for a first application that initiated the first event on the user device, wherein the second set of event data comprises a second identifier for a second application that initiated the second event on the user device, and wherein the correlation between the first event and the second event is determined based on the first identifier and the second identifier.

3. The method of claim 2, wherein the first application and the second application are the same application.

4. The method of claim 1, wherein the correlation between the first event and the second event is determined based on a respective time that the first event and the second event were received or initialed on the user device.

5. The method of claim 1, comprising:
after receiving the first set of event data, redirecting the request for the web feed to the publisher.

6. The method of claim 1, comprising:
after receiving the first set of event data, providing a location of the web feed to the user device.

7. The method of claim 6, wherein the location of the web feed is provided to a podcast application executed by the user device.

8. The method of claim 1, comprising:
after receiving the second set of event data, redirecting the request for the audio file to the publisher.

9. The method of claim 1, comprising:
after receiving the second set of event data, providing a location of the audio file to the user device.

10. The method of claim 9, wherein the location of the audio file is provided to a podcast application executed by the user device.

11. The method of claim 1, wherein the first event is initiated from the user device via a shared link provided by the publisher.

12. The method of claim 11, wherein the correlation between the first event and the second event is provided to the publisher within a summary of events, for a given timeframe, initiated via the shared link correlated to events for downloads of the audio file or related audio files.

13. The method of claim 12, wherein the summary of events is provided to the publisher via a user interface.

14. The method of claim 13, wherein the summary of events comprises at least one million correlated events.

15. The method of claim 1, wherein the second event is initiated from the user device via a prefix code embedded in the web feed.

16. The method of claim 1, wherein the web feed comprises a location of the audio file.

17. The method of claim 1, wherein the web feed comprises a Rich Site Summary (RSS) feed.

18. The method of claim 17, wherein the RSS feed is maintained by the publisher.

19. The method of claim 1, wherein the audio file comprises a Moving Picture Experts Group (MPEG) Audio Layer-3 (MP3) file.

20. The method of claim 1, wherein the audio file comprises an episode of a podcast.

21. The method of claim 1, wherein the second set of event data is instead received from a second user device associated with the IP address.

22. The method of claim 1, comprising:
receiving, from the user device, subsequent sets of event data for the second event, wherein the second event comprises a request for a portion of the audio file, and wherein the second set of event data and each of the subsequent sets of event data comprise the portion of the audio file requested;
determining, as a download indicator, whether an entirety of the audio file has been downloaded by the user device based on the received second set of event data and the subsequent sets of event data; and
providing the download indicator to the publisher of the audio file.

23. One or more non-transitory computer-readable storage media coupled to one or more processors and having instructions stored thereon which, when executed by the one or more processors, cause the one or more processors to perform operations comprising:
receiving, from a user device, a first set of event data for a first event, the first event comprising a request for a web feed associated with an audio file, the first set of event data comprising an internet protocol (IP) address associated with the user device;
receiving, from the user device, a second set of event data for a second event, the second event comprising a request for the audio file, the second set of event data comprising the IP address associated with the user device;
processing the first set of event data and the second set of event data to determine a correlation between the first event and the second event based on the IP address associated with the user device; and
providing the correlation between the first event and the second event to a publisher of the audio file.

24. An event correlation system, comprising:
a user device;
one or more processors; and
a computer-readable storage device coupled to the one or more processors and having instructions stored thereon which, when executed by the one or more processors, cause the one or more processors to perform operations comprising:
receiving, from the user device, a first set of event data for a first event, the first event comprising a request for a web feed associated with an audio file, the first set of event data comprising an internet protocol (IP) address associated with the user device;
receiving, from the user device, a second set of event data for a second event, the second event comprising a request for the audio file, the second set of event data comprising the IP address associated with the user device;
processing the first set of event data and the second set of event data to determine a correlation between the first event and the second event based on the IP address associated with the user device; and
providing the correlation between the first event and the second event to a publisher of the audio file.
